(19) United States
(12) Patent Application Publication
(10) Pub. No.: US 2025/0101996 A1
(43) Pub. Date: Mar. 27, 2025

(54) HYDRAULIC OIL SUPPLY DEVICE FOR INDUSTRIAL VEHICLE

(71) Applicant: KABUSHIKI KAISHA TOYOTA JIDOSHOKKI, Kariya-shi, Aichi (JP)

(72) Inventor: Eisuke KONDO, Kariya-shi, Aichi (JP)

(73) Assignee: KABUSHIKI KAISHA TOYOTA JIDOSHOKKI, Kariya-shi, Aichi (JP)

(21) Appl. No.: 18/832,430

(22) PCT Filed: Jan. 18, 2023
(86) PCT No.: PCT/JP2023/001308

§ 371 Date: Jul. 23, 2024

(30) Foreign Application Priority Data
Jan. 25, 2022 (JP) 2022-009260

(51) Int. Cl. F15B 1/26; B66F 9/22

(52) U.S. Cl. CPC F15B 1/265; B66F 9/22; F15B 2211/20515

(57) ABSTRACT

A hydraulic oil supply device for an industrial vehicle includes: a first hydraulic oil tank; a second hydraulic oil tank; an upper communication pipe; a lower communication pipe; a first hydraulic oil pipe configured to communicate the first hydraulic oil tank with a hydraulic oil supply target and to be provided with a suction port; a second hydraulic oil pipe configured to communicate the hydraulic oil supply target with the second hydraulic oil tank and to be provided with a discharge port; and a hydraulic oil pump. The second hydraulic oil tank is an airtight tank sealed hermetically against outside air. The upper communication pipe has a first open-end portion and a second open-end portion. The first open-end portion has an opening height higher than an opening height of the suction port. The second open-end portion has an opening height higher than an opening height of the discharge port.

### CROSS REFERENCE TO RELATED APPLICATIONS

This application is a National Stage of International Application No. PCT/JP2023/001308 filed Jan. 18, 2023, claiming priority based on Japanese Patent Application No. 2022-009260 filed Jan. 25, 2022.

### TECHNICAL FIELD

The present disclosure relates to a hydraulic oil supply device for an industrial vehicle.

### BACKGROUND ART

As the conventional technique of a hydraulic oil supply device for an industrial vehicle, for example, the structure of a plurality of hydraulic oil tanks disclosed in Patent Literature 1 is known. The structure of the plurality of hydraulic oil tanks disclosed in Patent Literature 1 is a structure of a plurality of closed pressurized hydraulic oil tanks accompanying a plurality of hydraulic units. In this structure of the hydraulic oil tank, a communication pipe for hydraulic oil circulation that communicates the oil phase portions of a plurality of sealed and pressurized hydraulic oil tanks with each other is provided to be joined to the lower surface of the hydraulic oil tank. In addition, a communication pipe for pressurized air circulation that communicates the gas phase portions with each other is provided to be joined near the upper surface of the hydraulic oil tank. According to the structure of the plurality of hydraulic oil tanks disclosed in Patent Literature 1, even with rapid changes in the inflow and outflow of oil within the hydraulic oil tank, the pressurized air acting on each oil level circulates mutually to maintain equilibrium, so the hydraulic oil in the hydraulic oil tank quickly flows into and out of each other through the communication pipe, synchronizing the oil level continuously.

Further, as another conventional technique, for example, a vehicle body structure for an industrial vehicle disclosed in Patent Literature 2 is known. In the vehicle body structure for an industrial vehicle in Patent Literature 2, it is disclosed that a forklift is provided with a hydraulic oil tank and a fuel tank on the left and right sides.

### CITATION LIST

### Patent Literature

Patent Literature 1: Japanese Unexamined Utility Model Publication No. S63-72301
Patent Literature 2: Japanese Unexamined Patent Publication No. H02-144228

### SUMMARY OF INVENTION

### Technical Problem

However, in the structure of the plurality of hydraulic oil tanks disclosed in Patent Literature 1, not only a communication pipe for hydraulic oil circulation that communicates the oil phase portions with each other and a communication pipe for pressurized air circulation that communicates the gas phase portions with each other are required, but also pneumatic equipment such as an air compressor and pneumatic piping are required. Additionally, requiring pneumatic equipment and pneumatic piping leads to the need for controlling the pneumatic equipment and adds complexity to the structure of the device. Furthermore, in the vehicle body structure for an industrial vehicle disclosed in Patent Literature 2, one of the tanks is a fuel tank, so there is no suggestion is made regarding potential issues that may occur in the case where the industrial vehicle is provided with multiple hydraulic oil tanks.

The present disclosure is intended to provide a hydraulic oil supply device for an industrial vehicle, which not only suppresses the expansion of a difference in oil level between a plurality of hydraulic oil tanks but also suppresses the leakage of hydraulic oil and the inflow of air into a hydraulic oil suction port during the inclination of a vehicle body.

### Solution to Problem

A hydraulic oil supply device for an industrial vehicle according to one aspect of the present disclosure includes a first hydraulic oil tank configured to store hydraulic oil; a second hydraulic oil tank configured to store the hydraulic oil; an upper communication pipe configured to communicate an upper part of the first hydraulic oil tank with an upper part of the second hydraulic oil tank; a lower communication pipe configured to communicate a lower part of the first hydraulic oil tank with a lower part of the second hydraulic oil tank to flow the hydraulic oil; a first hydraulic oil pipe configured to communicate the first hydraulic oil tank with a hydraulic oil supply target subjected to supplying the hydraulic oil and to be provided, in the first hydraulic oil tank, with a suction port adapted to draw the hydraulic oil; a second hydraulic oil pipe configured to communicate the hydraulic oil supply target with the second hydraulic oil tank and to be provided with a discharge port adapted to discharge the hydraulic oil to be returned to the second hydraulic oil tank; and a hydraulic oil pump configured to draw up the hydraulic oil from the first hydraulic oil tank. The second hydraulic oil tank is an airtight tank sealed hermetically against outside air, the upper communication pipe has a first open-end portion provided inside the first hydraulic oil tank and a second open-end portion provided inside the second hydraulic oil tank, the first open-end portion has an opening height higher than an opening height of the suction port, and the second open-end portion has an opening height higher than an opening height of the discharge port.

In the hydraulic oil supply device for an industrial vehicle according to one aspect of the present disclosure, when the hydraulic oil pump draws up the hydraulic oil in the first hydraulic oil tank, the oil level in the first hydraulic oil tank drops. Even if the oil level in the first hydraulic oil tank drops, when it reaches the second open-end portion of the upper communication pipe, the internal pressure of the second hydraulic oil tank rises, which causes the flow rate of the hydraulic oil from the second hydraulic oil tank to the first hydraulic oil tank to increase. This suppresses the expansion of a difference in oil level between the first hydraulic oil tank and the second hydraulic oil tank. Additionally, even if the vehicle body is tilted such that the first hydraulic oil tank is positioned lower than the second hydraulic oil tank, the second hydraulic oil tank is a hermetically sealed airtight tank, so the immersion of the first open-end portion into the hydraulic oil stops the displacement of the oil levels in the first hydraulic oil tank and the second hydraulic oil tank. Thus, leakage of the hydraulic oil from the first hydraulic oil tank to the outside due to the inclination of the vehicle body is suppressed. On the other hand, even if the vehicle body is tilted such that the second hydraulic oil tank is positioned lower than the first hydraulic oil tank, the immersion of the second open-end portion into the hydraulic oil stops the displacement of the oil levels in the first hydraulic oil tank and the second hydraulic oil tank. Thus, it is possible to suppress the inflow of air into the suction port caused by the oil level in the first hydraulic oil tank dropping lower than the suction port due to the inclination of the vehicle body.

In one embodiment, the hydraulic oil supply device for an industrial vehicle may include a breather connected to the first hydraulic oil tank. The hydraulic oil is sent from the first hydraulic oil tank to the second hydraulic oil tank via the hydraulic oil supply target, and returning this hydraulic oil from the second hydraulic oil tank to the first hydraulic oil tank requires pressurizing the inside of the second hydraulic oil tank. Thus, the second hydraulic oil tank is not suitable for a location where the breather is provided. The installation of the breather in the first hydraulic oil tank can eliminate the need to provide the breather in the second hydraulic oil tank.

In one embodiment, the hydraulic oil supply device for an industrial vehicle may include a pressure-regulating valve connected to the first hydraulic oil tank and configured to communicate the interior of the first hydraulic oil tank with outside air upon the pressure in the space in the first hydraulic oil tank higher than or equal to a predetermined pressure. In this case, it is possible to make the pressure in the space in the first hydraulic oil tank higher than atmospheric pressure. As a result, it becomes easier for the hydraulic oil pump to draw up the hydraulic oil from the first hydraulic oil tank. This enables extending the service life of the hydraulic oil pump.

In one embodiment, the opening height of the second open-end portion may be lower than the opening height of the first open-end portion or the same as the opening height of the first open-end portion. In this case, it is possible to suppress the oil level in the second hydraulic oil tank from rising above the second open-end portion. In particular, when the opening height of the second open-end portion is the same as the opening height of the first open-end portion, it is difficult for a difference in oil level between the first hydraulic oil tank and the second hydraulic oil tank to occur, even if the vehicle body is tilted.

In one embodiment, the hydraulic oil supply device for an industrial vehicle may include a third hydraulic oil pipe configured to communicate the second hydraulic oil tank with the hydraulic oil supply target and provided, in the second hydraulic oil tank, with a suction port adapted to draw the hydraulic oil, and a second hydraulic oil pump configured to draw up the hydraulic oil from the second hydraulic oil tank. In this case, the third hydraulic oil pipe and the second hydraulic oil pump allow the hydraulic oil to be drawn not only from the first hydraulic oil tank but also from the second hydraulic oil tank. This makes it possible to sufficiently supply the necessary hydraulic oil to the hydraulic oil supply target, improving the operational speed of the hydraulic oil supply target.

### Advantageous Effects of Invention

According to the present disclosure, it is possible to provide a hydraulic oil supply device for an industrial vehicle, which not only suppresses the expansion of a difference in oil level between a plurality of hydraulic oil tanks but also suppresses the leakage of hydraulic oil and the inflow of air into a hydraulic oil suction port during the inclination of a vehicle body.

### BRIEF DESCRIPTION OF DRAWINGS

FIG. 1 is a plan view of a forklift with a hydraulic oil supply device applied according to a first embodiment.

FIG. 2 is a configuration diagram schematically illustrating the hydraulic oil supply device for a forklift according to the first embodiment.

FIG. 3 (a) is a diagram illustrating a state where the oil level is displaced in the case of driving a hydraulic oil pump. FIG. 3 (b) is a diagram illustrating a state where the displacement of the oil level is stopped.

FIG. 4 (a) is a diagram of a state immediately after the inclination of a vehicle body where the left side is downward. FIG. 4 (b) is a diagram illustrating a state where the displacement of the oil level is stopped during the inclination of a vehicle body with the left side facing downward.

FIG. 5 (a) is a diagram of a state immediately after the inclination of a vehicle body where the right side is downward. FIG. 5 (b) is a diagram illustrating a state where the displacement of the oil level is stopped during the inclination of a vehicle body with the right side facing downward.

FIG. 6 is a configuration diagram schematically illustrating a hydraulic oil supply device for a forklift according to a modification of the first embodiment.

FIG. 7 is a configuration diagram schematically illustrating a hydraulic oil supply device for a forklift according to a second embodiment.

FIG. 8 is a configuration diagram schematically illustrating a hydraulic oil supply device for a forklift according to a third embodiment.

FIG. 9 is a schematic partial cross-sectional view illustrating an example of the valve structure of a pressure-regulating valve.

FIG. 10 is a partial cross-sectional view illustrating an exemplary operation of the pressure-regulating valve in FIG. 9.

FIG. 11 is a schematic perspective view illustrating an example of a mounting configuration of a breather and a pressure-regulating valve on a first hydraulic oil tank.

FIG. 12 is a configuration diagram schematically illustrating a hydraulic oil supply device for a forklift, which has the mounting configuration illustrated in FIG. 11.

### DESCRIPTION OF EMBODIMENTS

### First Embodiment

A hydraulic oil supply device for an industrial vehicle according to a first embodiment is described below with reference to the drawings. In the present embodiment, a hydraulic oil supply device for a forklift is exemplified and described. Note that “front and rear”, “left and right”, or “up and down” to specify directions correspond to a direction based on a forklift operator sitting in the driver seat and facing the forward direction of the forklift.

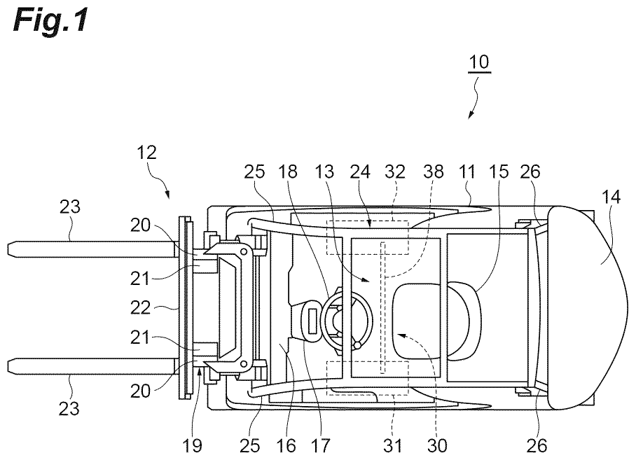

An overview of a forklift is now described. As illustrated in FIG. 1, a forklift 10 includes a load-handling device 12 at the front of a vehicle body 11. Near the center of the vehicle body 11, a driver's compartment 13 is provided. At the front of the vehicle body 11, drive wheels (not illustrated) are provided as front wheels. At the rear of the vehicle body 11, steerable wheels (not illustrated) are provided as rear wheels. At the rear of the vehicle body 11, a counterweight 14 is arranged. The counterweight 14 is provided to adjust the vehicle weight and achieve a weight balance in the vehicle body 11. The forklift 10 of the present embodiment is a battery-powered forklift, equipped with an electric motor for traveling (not illustrated) and a battery (not illustrated) mounted on the vehicle body 11.

In the driver's compartment 13 provided in the vehicle body 11, a driver's seat 15 is provided. The driver's seat 15 is a seat on which an operator of the forklift 10 sits. In the front of the driver's seat 15, an instrument panel 16 is provided. The instrument panel 16 is provided with a steering column 17. The steering column 17 is provided with a steering wheel 18.

The load-handling device 12 has a mast 19 including an outer mast 20 and an inner mast 21. The pair of left and right outer masts 20 are provided with the inner mast 21 that is slidable inside the outer masts 20. Between the vehicle body 11 and the outer mast 20, a tilt cylinder (not illustrated) operated by hydraulic pressure is provided. The mast 19 tilts in the forward and backward direction around its lower end portion as a pivot point through the actuation of the tilt cylinder. The mast 19 is provided with a hydraulically operated lift cylinder (not illustrated). Through the actuation of the lift cylinder, the inner mast 21 slides within the outer mast 20 and moves up and down.

On the mast 19, a pair of left and right forks 23 are provided via a lift bracket 22. The lift bracket 22 is provided to move up and down along with the inner mast 21. In other words, the lift bracket 22 is movable up and down relative to the outer mast 20. Moreover, the left and right forks 23 have the same configuration.

The vehicle body 11 is provided with a head guard 24 that covers the upper part of the driver's compartment 13. The head guard 24 is supported by a pair of left and right front pillars 25 erected from the front of the vehicle body 11 and by a pair of left and right rear pillars 26 erected from the rear of the vehicle body 11.

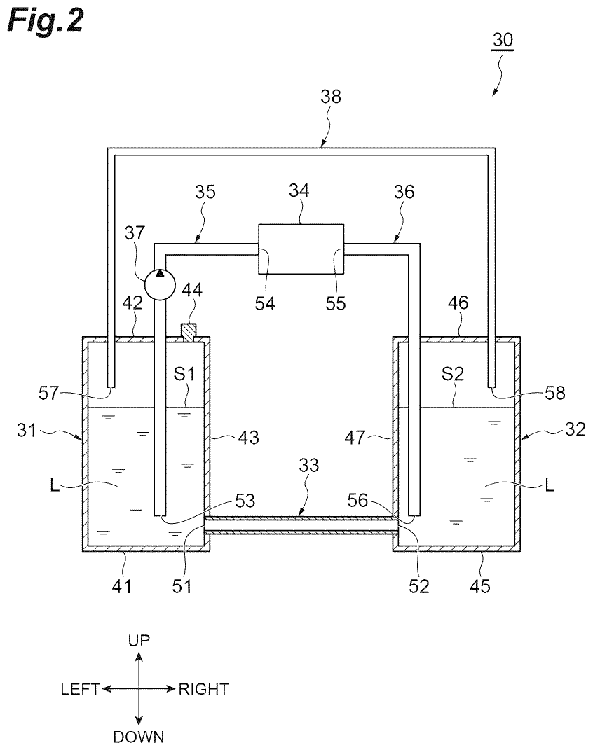

Further, in the present embodiment, the vehicle body 11 is mounted with a hydraulic oil supply device 30 for the forklift 10 (hydraulic oil supply device for an industrial vehicle). In the following description, the hydraulic oil supply device 30 for the forklift 10 will be simply referred to as “hydraulic oil supply device 30”. As illustrated in FIG. 2, the hydraulic oil supply device 30 includes a first hydraulic oil tank 31, a second hydraulic oil tank 32, a lower communication pipe 33, a hydraulic oil supply target 34, a first hydraulic oil pipe 35, a second hydraulic oil pipe 36, a hydraulic oil pump 37, and an upper communication pipe 38.

The first hydraulic oil tank 31 is a tank that stores hydraulic oil L. The first hydraulic oil tank 31 is arranged on the left side of the driver's compartment 13 in the vehicle body 11 (refer to FIG. 1). The first hydraulic oil tank 31 has a bottom plate 41, a top plate 42, and a side plate 43. The side plate 43 is provided between the bottom plate 41 and the top plate 42. The first hydraulic oil tank 31 is an airtight tank with high airtightness. There is provided a breather 44 connected to the top plate 42. In the example of FIG. 2, the breather 44 is directly connected to the top plate 42 of the first hydraulic oil tank 31. The breather 44 discharges air to the outside if the pressure inside the space in the first hydraulic oil tank 31 becomes higher than atmospheric pressure. The breather 44 draws air from the outside if the pressure inside the space in the first hydraulic oil tank 31 becomes lower than atmospheric pressure. The top plate 42 has the first hydraulic oil pipe 35 inserted into it. The top plate 42 has the upper communication pipe 38 inserted into it.

The second hydraulic oil tank 32 is a tank that stores the hydraulic oil L. The second hydraulic oil tank 32 is arranged on the right side of the driver's compartment 13 in the vehicle body 11 (refer to FIG. 1). The second hydraulic oil tank 32 has a bottom plate 45, a top plate 46, and a side plate 47, which is similar to the first hydraulic oil tank 31. The side plate 47 is provided between the bottom plate 45 and the top plate 46. The second hydraulic oil tank 32 is an airtight tank with high airtightness. The top plate 46 has the second hydraulic oil pipe 36 inserted into it. The top plate 46 has the upper communication pipe 38 inserted into it. The bottom plate 45 is at the same height as the bottom plate 41 of the first hydraulic oil tank 31 in the vertical direction of the vehicle body 11. The top plate 46 is at the same height as the top plate 42 of the first hydraulic oil tank 31 in the vertical direction of the vehicle body 11. Moreover, in the present embodiment, the vehicle body of an engine-powered forklift is repurposed as the vehicle body 11 of a battery-powered forklift, and the fuel tank of the engine-powered forklift is utilized as the first hydraulic oil tank 31.

The lower communication pipe 33 is a pipe that communicates the lower part of the first hydraulic oil tank 31 and the lower part of the second hydraulic oil tank 32. Specifically, the lower communication pipe 33 has one end portion 51 connected near a lower part of the side plate 43 in the first hydraulic oil tank 31. The lower communication pipe 33 has the other end portion 52 connected near the lower part of the side plate 47 in the second hydraulic oil tank 32. Thus, the hydraulic oil L stored in the first hydraulic oil tank 31 and the second hydraulic oil tank 32 is movable through the lower communication pipe 33.

The hydraulic oil supply target 34 can be various hydraulic circuits, hydraulic equipment, or the like that require hydraulic oil L. An example of the hydraulic oil supply target 34 includes a load handling system hydraulic circuit, which includes a lift cylinder and a tilt cylinder equipped by the load-handling device 12. Additionally, the hydraulic oil supply target 34 may also be a hydraulic braking system circuit or a hydraulic steering system circuit. The first hydraulic oil pipe 35 is a hydraulic oil pipe that connects the first hydraulic oil tank 31 with the hydraulic oil supply target 34. The end portion of the first hydraulic oil pipe 35 on the side of the first hydraulic oil tank 31 is a suction port 53. The suction port 53 is provided close to the bottom plate 41, ensuring that it is sufficiently immersed in the stored hydraulic oil L in the state where the vehicle body 11 is not tilted. On the side opposite the suction port 53 of the first hydraulic oil pipe 35, there is an end portion 54 connected to the hydraulic oil supply target 34.

The hydraulic oil pump 37 is provided in the first hydraulic oil pipe 35. The hydraulic oil pump 37 is a pump capable of drawing up the hydraulic oil L stored in the first hydraulic oil tank 31. The hydraulic oil pump 37 is, for example, a gear pump. The hydraulic oil pump 37 is driven by the drive of an electric motor (not illustrated) for the pump. The hydraulic oil pump 37 supplies the hydraulic oil supply target 34 with the hydraulic oil L drawn up through the first hydraulic oil pipe 35.

The second hydraulic oil pipe 36 is a hydraulic oil pipe that connects the hydraulic oil supply target 34 with the second hydraulic oil tank 32. The second hydraulic oil pipe 36 has an end portion 55 connected to the hydraulic oil supply target 34. The end portion of the second hydraulic oil pipe 36 on the side of the second hydraulic oil tank 32 is a discharge port 56. The discharge port 56 is provided close to the bottom plate 45, ensuring that it is sufficiently immersed in the stored hydraulic oil L in the state where the vehicle body 11 is not tilted. The discharge port 56 of the second hydraulic oil pipe 36 has the opening height that is the same as the opening height of the suction port 53 of the first hydraulic oil pipe 35. Thus, the hydraulic oil L supplied to the hydraulic oil supply target 34 returns to the second hydraulic oil tank 32 through the second hydraulic oil pipe 36.

The upper communication pipe 38 is a pipe that communicates the upper part of the first hydraulic oil tank 31 with the upper part of the second hydraulic oil tank 32. Further, in the present embodiment, the upper communication pipe 38 is provided to cross above the top of an electric motor for load handling, which is not illustrated. The upper communication pipe 38 penetrates the top plate 42 of the first hydraulic oil tank 31. The upper communication pipe 38 has a first open-end portion 57 on the side of the first hydraulic oil tank 31, with an opening height higher than that of the suction port 53 of the first hydraulic oil pipe 35. The upper communication pipe 38 penetrates the top plate 46 of the second hydraulic oil tank 32. The upper communication pipe 38 has a second open-end portion 58 on the side of the second hydraulic oil tank 32, with an opening height higher than that of the discharge port 56 of the second hydraulic oil pipe 36. The upper communication pipe 38 has a diameter smaller than that of the lower communication pipe 33.

In the hydraulic oil supply device 30 of the present embodiment, in the state where the vehicle body 11 is not tilted, the hydraulic oil L is stored in the first hydraulic oil tank 31 and the second hydraulic oil tank 32 to such an extent that their respective oil levels S1 and S2 of the hydraulic oil L do not reach the first open-end portion 57 and the second open-end portion 58 of the upper communication pipe 38 (refer to FIG. 2). The vehicle body 11 not being tilted refers, for example, to the forklift 10 being stationary on a horizontal road surface.

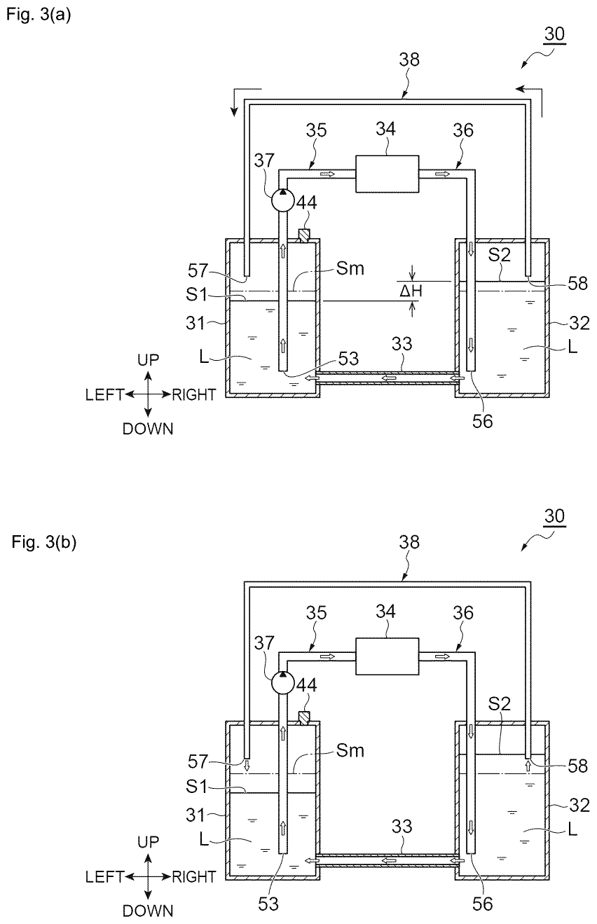

The operation of the hydraulic oil supply device 30 of the present embodiment is now described. To begin with, in the hydraulic oil supply device 30 in the state where the vehicle body 11 is not tilted, the operation of the hydraulic oil pump 37 causes the hydraulic oil L from the first hydraulic oil tank 31 to be drawn up. The hydraulic oil L drawn up is supplied to the hydraulic oil supply target 34. As illustrated in FIG. 3 (a), the oil level S1 in the first hydraulic oil tank 31 drops due to the drawing up of the hydraulic oil L by the hydraulic oil pump 37. Thus, the pressure in the space in the first hydraulic oil tank 31 decreases.

On the other hand, the hydraulic oil L from the hydraulic oil supply target 34 is collected into the second hydraulic oil tank 32 through the second hydraulic oil pipe 36. Thus, as illustrated in FIG. 3 (a), the oil level S2 in the second hydraulic oil tank 32 rises. For that reason, the pressure in the space in the second hydraulic oil tank 32 increases. However, the pressure in the space in the second hydraulic oil tank 32 is released to the space in the first hydraulic oil tank 31 through the upper communication pipe 38. Additionally, the driving of the hydraulic oil pump 37 causes the difference between the oil level S1 in the first hydraulic oil tank 31 and the oil level S2 in the second hydraulic oil tank 32 to increase. Due to a head (hydraulic head) difference ΔH, the hydraulic oil L in the second hydraulic oil tank 32 flows to the first hydraulic oil tank 31 through the lower communication pipe 33. The flow rate of the hydraulic oil L flowing through the lower communication pipe 33 depends on the head difference ΔH. If the flow rate of the lower communication pipe 33 increases and matches the flow rate of the second hydraulic oil pipe 36, then the head difference ΔH becomes unchanging. In this state, the oil level S1 in the first hydraulic oil tank 31 and the oil level S2 in the second hydraulic oil tank 32 are maintained along with the head difference ΔH during the driving of the hydraulic oil pump 37.

Moreover, it is conceivable that the oil level S2 in the second hydraulic oil tank 32 may become higher than the second open-end portion 58 of the upper communication pipe 38, as illustrated in FIG. 3 (b), in the case where the head difference ΔH increases. In this case, as the pressure in the space in the second hydraulic oil tank 32 increases, the hydraulic oil L in the second hydraulic oil tank 32 flows through the upper communication pipe 38 and flows into the first hydraulic oil tank 31. Additionally, in the lower communication pipe 33, the increase in the pressure in the space in the second hydraulic oil tank 32 causes the flow rate of the hydraulic oil L flowing into the first hydraulic oil tank 31 to increase. In other words, the second open-end portion 58 defines the upper limit of the oil level S2. Thus, the difference between the oil level S1 in the first hydraulic oil tank 31 and the oil level S2 in the second hydraulic oil tank 32 is suppressed from being larger. In FIGS. 3 (a) and 3 (b), the dashed line indicates an oil level Sm under the state where there is no difference between the levels.

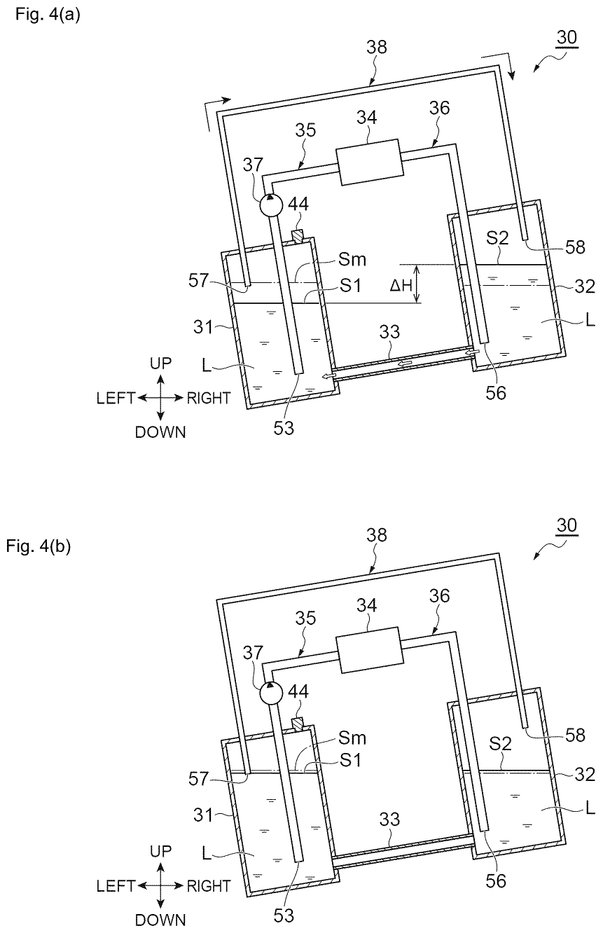

Subsequently, the operation of the hydraulic oil supply device 30 in the state where the vehicle body 11 is tilted with the right side up and the left side down, as illustrated in FIG. 4 (a), will be described. Moreover, the description pertains to a case in which the hydraulic oil pump 37 is not driven when the vehicle is tilted. Immediately after the vehicle body 11 is tilted as in the example of FIG. 4 (a), there is a significant difference between the oil level S1 of the hydraulic oil L in the first hydraulic oil tank 31 and the oil level S2 of the hydraulic oil L in the second hydraulic oil tank 32. Specifically, the oil level S1 of the hydraulic oil L in the first hydraulic oil tank 31 is lower, while the oil level S2 of the hydraulic oil L in the second hydraulic oil tank 32 is higher. Thus, the head (hydraulic head) difference ΔH causes the hydraulic oil L in the second hydraulic oil tank 32 to flow to the first hydraulic oil tank 31 through the lower communication pipe 33. The flow of the hydraulic oil L from the second hydraulic oil tank 32 to the first hydraulic oil tank 31 causes the oil level S1 in the first hydraulic oil tank 31 to rise and the oil level S2 in the second hydraulic oil tank 32 to drop. The rise in the oil level S1 of the first hydraulic oil tank 31 causes the pressure in the space in the first hydraulic oil tank 31 to increase. The pressure in the space in the first hydraulic oil tank 31 is released to the space in the second hydraulic oil tank 32 through the upper communication pipe 38.

As illustrated in FIG. 4 (b), the continued rise of the oil level S1 in the first hydraulic oil tank 31 and the immersion of the first open-end portion 57 of the upper communication pipe 38 into the hydraulic oil L make it impossible for air to pass through the upper communication pipe 38. This makes it impossible for the hydraulic oil L in the second hydraulic oil tank 32 to move to the first hydraulic oil tank 31 through the lower communication pipe 33. The oil level S1 in the first hydraulic oil tank 31 stops rising. In other words, the condition arises where the difference between the oil level S1 of the hydraulic oil L in the first hydraulic oil tank 31 and the oil level S2 of the hydraulic oil L in the second hydraulic oil tank 32 remains unresolved. The rise in the oil level S1 of the hydraulic oil L in the first hydraulic oil tank 31 is stopped when the first open-end portion 57 of the upper communication pipe 38 is immersed in the hydraulic oil L. Thus, the hydraulic oil L from the breather 44 is suppressed from leaking. In FIGS. 4 (a) and 4 (b), the dashed line indicates the oil level Sm under the state where there is no difference between the levels.

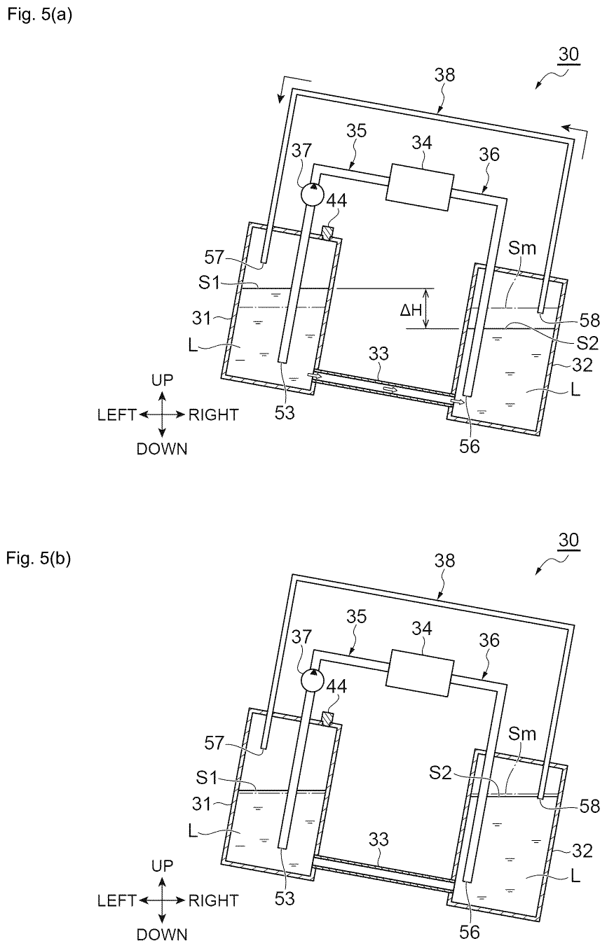

Subsequently, the operation of the hydraulic oil supply device 30 in the state where the vehicle body 11 is tilted with the left side up and the right side down, as illustrated in FIG. 5 (a), will be described. Moreover, the description pertains to a case in which the hydraulic oil pump 37 is not driven when the vehicle is tilted. Immediately after the vehicle body 11 is tilted as in the example of FIG. 5 (a), there is a significant difference between the oil level S1 of the hydraulic oil L in the first hydraulic oil tank 31 and the oil level S2 of the hydraulic oil L in the second hydraulic oil tank 32. Specifically, the oil level S1 of the hydraulic oil L in the first hydraulic oil tank 31 is higher, and the oil level S2 of the hydraulic oil L in the second hydraulic oil tank 32 is lower. Thus, the head (hydraulic head) difference ΔH causes the hydraulic oil L in the first hydraulic oil tank 31 to flow to the second hydraulic oil tank 32 through the lower communication pipe 33. The flow of the hydraulic oil L from the first hydraulic oil tank 31 to the second hydraulic oil tank 32 causes the oil level S2 in the second hydraulic oil tank 32 to rise and the oil level S1 in the first hydraulic oil tank 31 to drop. The rise in the oil level S2 of the second hydraulic oil tank 32 causes the pressure in the space in the second hydraulic oil tank 32 to increase. The pressure in the space in the second hydraulic oil tank 32 is released to the space in the first hydraulic oil tank 31 through the upper communication pipe 38.

As illustrated in FIG. 5 (b), the continued rise of the oil level S2 in the second hydraulic oil tank 32 and the immersion of the second open-end portion 58 of the upper communication pipe 38 into the hydraulic oil L make it impossible for air to pass through the upper communication pipe 38. This makes it impossible for the hydraulic oil L in the first hydraulic oil tank 31 to move to the second hydraulic oil tank 32 through the lower communication pipe 33. The oil level S2 in the second hydraulic oil tank 32 stops rising. In other words, the condition arises where the difference between the oil level S1 of the hydraulic oil L in the first hydraulic oil tank 31 and the oil level S2 of the hydraulic oil L in the second hydraulic oil tank 32 remains unresolved. The rise in the oil level S2 of the hydraulic oil L in the second hydraulic oil tank 32 is stopped when the second open-end portion 58 of the upper communication pipe 38 is immersed in the hydraulic oil L. The oil level S1 of the hydraulic oil L in the first hydraulic oil tank 31 also stops without further dropping. Thus, even if the vehicle body 11 is tilted as illustrated in the example of FIG. 5 (b), excessive lowering of the oil level S1 of the hydraulic oil L in the first hydraulic oil tank 31 to expose the suction port 53 of the first hydraulic oil pipe 35 to the space is prevented. As a result, even if the hydraulic oil pump 37 is driven in the state where the vehicle body 11 is tilted as in the example of FIG. 5 (b), the immediate inflow of air through the suction port 53 is suppressed. In FIGS. 5 (a) and 5 (b), the dashed line indicates the oil level Sm under the state where there is no difference between the levels.

The hydraulic oil supply device 30 of the present embodiment achieves the following effects. When the hydraulic oil pump 37 draws up the hydraulic oil L in the first hydraulic oil tank 31, the oil level S1 in the first hydraulic oil tank 31 drops. Even if the oil level S1 of the first hydraulic oil tank 31 drops, reaching the oil level at the second open-end portion 58 of the upper communication pipe 38 increases the pressure in the space in the second hydraulic oil tank 32, thereby causing the flow rate of hydraulic oil L from the second hydraulic oil tank 32 to the first hydraulic oil tank 31 to increase. Thus, the difference between the oil levels S1 and S2 in the first hydraulic oil tank 31 and the second hydraulic oil tank 32, respectively, is suppressed from being larger. Even if the vehicle body 11 is tilted due to the first hydraulic oil tank 31 being lower than the second hydraulic oil tank 32, the immersion of the first open-end portion 57 into the hydraulic oil L stops the displacement of the oil levels S1 and S2 in the first hydraulic oil tank 31 and the second hydraulic oil tank 32, respectively. In other words, the first open-end portion 57 defines the upper limit of the oil level S1. Thus, leakage of the hydraulic oil L from the first hydraulic oil tank 31 to the outside due to the inclination of the vehicle body 11 is suppressed. On the other hand, even if the vehicle body 11 is tilted such that the second hydraulic oil tank 32 is positioned lower than the first hydraulic oil tank 31, the immersion of the second open-end portion 58 into the hydraulic oil L stops the displacement of the oil levels S1 and S2 in the first hydraulic oil tank 31 and the second hydraulic oil tank 32, respectively. In other words, the second open-end portion 58 defines the upper limit of the oil level S2. Thus, it is possible to suppress the inflow of air into the suction port 53 caused by the oil level S1 in the first hydraulic oil tank 31 dropping lower than the suction port 53 due to the inclination of the vehicle body 11.

The hydraulic oil L is sent from the first hydraulic oil tank 31 to the second hydraulic oil tank 32 via the hydraulic oil supply target 34, and returning this hydraulic oil from the second hydraulic oil tank 32 to the first hydraulic oil tank 31 requires pressurizing the inside of the second hydraulic oil tank 32. Thus, the second hydraulic oil tank 32 is not suitable for the location where the breather is provided. The installation of the breather 44 in the first hydraulic oil tank 31 can eliminate the need for providing the breather 44 in the second hydraulic oil tank 32.

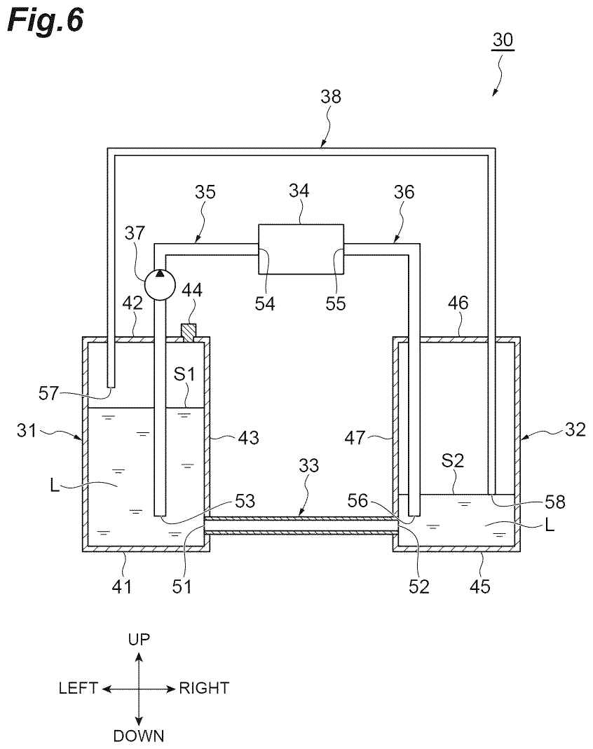

Moreover, in the present embodiment, the opening heights of the first open-end portion 57 and the second open-end portion 58 of the upper communication pipe 38 are set to be substantially the same height, but as illustrated in FIG. 6, the opening height of the second open-end portion 58 may be lower than the opening height of the first open-end portion 57. For example, making the opening height of the second open-end portion 58 slightly higher than the opening height of the discharge port 56 enables the amount of the hydraulic oil L stored in the second hydraulic oil tank 32 to be reduced.

### Second Embodiment

The description is now given on a hydraulic oil supply device according to a second embodiment. The present embodiment differs from the first embodiment in that a hydraulic oil pipe and a hydraulic pump for drawing up the hydraulic oil from the second hydraulic oil tank are provided. In the present embodiment, for components having the same configuration as the first embodiment, the description of the first embodiment is referenced, and common reference numerals are used.

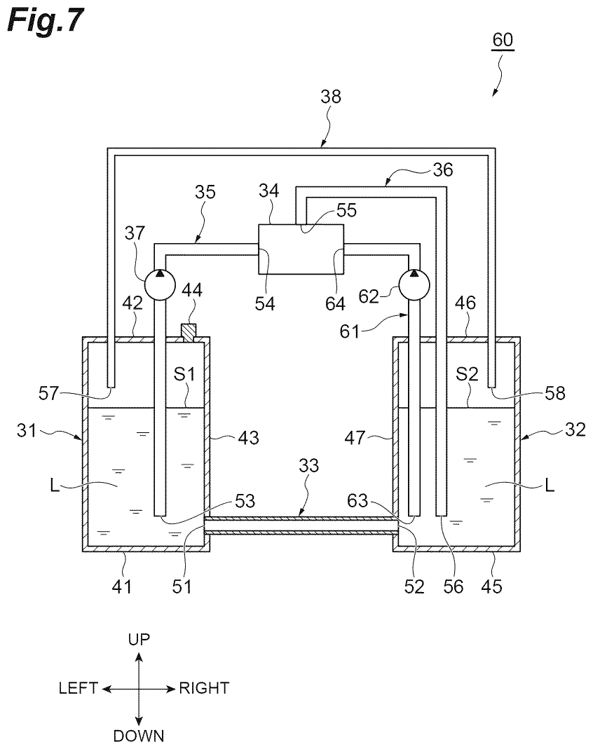

As illustrated in FIG. 7, a hydraulic oil supply device 60 includes a third hydraulic oil pipe 61 and a second hydraulic oil pump 62. The third hydraulic oil pipe 61 is a hydraulic oil pipe that connects the second hydraulic oil tank 32 with the hydraulic oil supply target 34. The end portion of the third hydraulic oil pipe 61 on the side of the second hydraulic oil tank 32 is a suction port 63. The suction port 63 is provided close to the bottom plate 45 so that it is sufficiently immersed in the stored hydraulic oil L in the state where the vehicle body 11 is not tilted. On the side opposite the suction port 63 of the third hydraulic oil pipe 61, there is an end portion 64 connected to the hydraulic oil supply target 34.

The third hydraulic oil pipe 61 is provided with the second hydraulic oil pump 62. The second hydraulic oil pump 62 is a pump capable of drawing up the hydraulic oil L stored in the second hydraulic oil tank 32. An example of the second hydraulic oil pump 62 includes a gear pump. The second hydraulic oil pump 62 is driven by the drive of an electric motor (not illustrated) for the pump. The second hydraulic oil pump 62 supplies the hydraulic oil supply target 34 with the hydraulic oil L drawn up through the third hydraulic oil pipe 61.

According to the present embodiment, the operational effects equivalent to the first embodiment are achieved. Further, in the present embodiment, the third hydraulic oil pipe 61 and the second hydraulic oil pump 62 are provided, so it is possible to draw up the hydraulic oil L not only from the first hydraulic oil tank 31 but also from the second hydraulic oil tank 32. Thus, even in the case where the hydraulic oil supply target 34 requires a large flow of the hydraulic oil L, it is possible to sufficiently supply the necessary hydraulic oil L to the hydraulic oil supply target 34, improving the operational speed of the hydraulic oil supply target 34.

### Third Embodiment

The description is now given on a hydraulic oil supply device according to a third embodiment. In the present embodiment, instead of the breather 44 that discharges air to the outside when the pressure in the space in the first hydraulic oil tank 31 becomes higher than atmospheric pressure, a hydraulic oil supply device 30A is provided with a pressure-regulating valve 70, differing from the first embodiment. The pressure-regulating valve is a valve configured to allow communication between the interior of the first hydraulic oil tank 31 and the outside air when the pressure in the space in the first hydraulic oil tank 31 is higher than or equal to a predetermined pressure. The predetermined pressure may be, for example, an atmospheric pressure higher than standard atmospheric pressure (1 atm: 101.33 kPa) by a predetermined set differential pressure. The set differential pressure may be a differential pressure to an extent to assist the hydraulic oil pump 37 in drawing up the hydraulic oil L from the first hydraulic oil tank 31. The set differential pressure may be such that when the hydraulic oil L in the first hydraulic oil tank 31 reaches a high temperature, the pressure in the space in the first hydraulic oil tank 31 is released. Specifically, when the temperature of the hydraulic oil L in the first hydraulic oil tank 31 increases, the temperature of the air layer in the first hydraulic oil tank 31 increases due to heat transfer from the hydraulic oil L, causing the pressure of the air layer to increase according to the Boyle-Charles law. To release the pressure in the space in the first hydraulic oil tank 31 when the temperature of the hydraulic oil L reaches a predetermined temperature, the pressure-regulating valve 70 is set to open at a differential pressure corresponding to the pressure of the air layer associated with the temperature of the relevant hydraulic oil L. In the present embodiment, for components having the same configuration as the first embodiment, the description of the first embodiment is referenced, and common reference numerals are used.

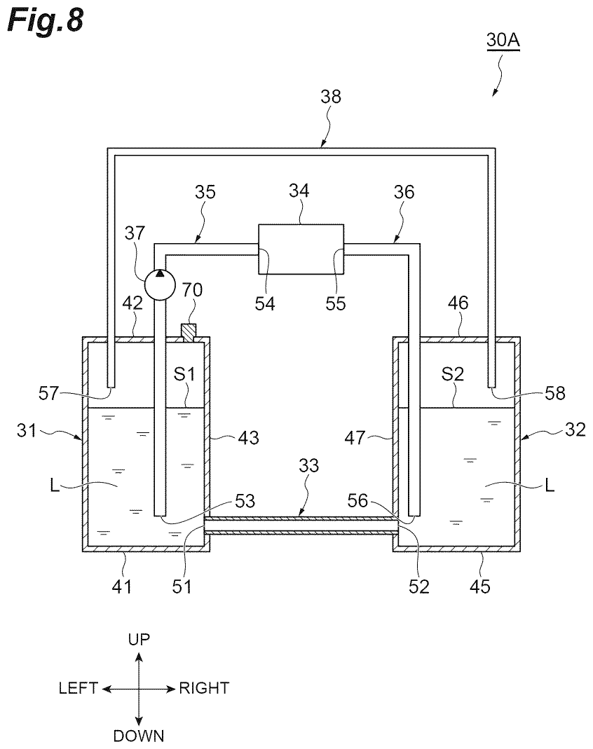

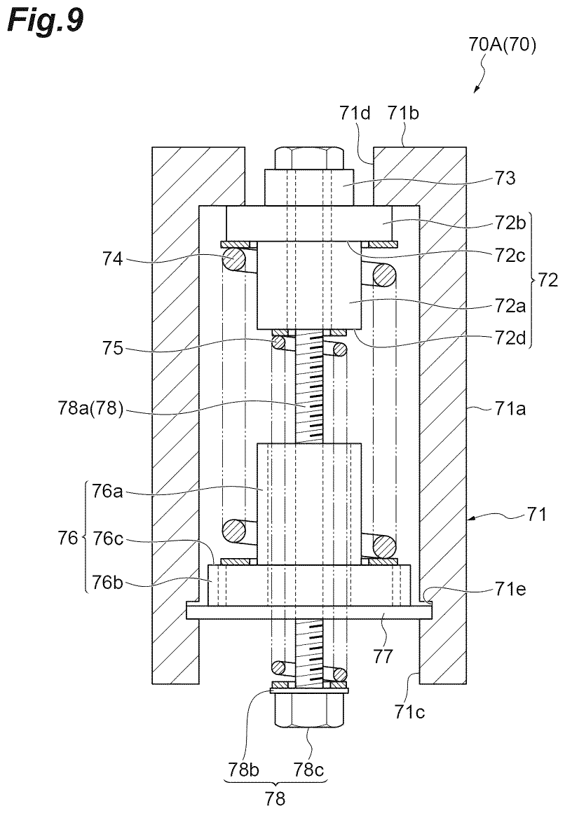

FIG. 8 is a configuration diagram schematically illustrating the hydraulic oil supply device for a forklift according to the third embodiment. FIG. 9 is a schematic partial cross-sectional view illustrating an example of the valve structure of the pressure-regulating valve. As illustrated in FIG. 8, the pressure-regulating valve 70 is connected to the top plate 42 of the first hydraulic oil tank 31. In the example of FIG. 8, the pressure-regulating valve 70 is directly connected to the top plate 42 of the first hydraulic oil tank 31. The pressure-regulating valve 70 has a valve structure 70A, which includes a housing 71, a first plunger 72, a second plunger 73, a first spring 74, a second spring 75, a retainer 76, a fastening member 78, and a snap ring 77. The pressure-regulating valve 70 is connected to the first hydraulic oil tank 31 such that the upper part of the valve structure 70A in FIG. 9 is on the atmosphere side, and the lower part of the valve structure 70A in FIG. 9 is on the internal side of the first hydraulic oil tank 31.

The housing 71 is a tubular (e.g., cylindrical) member that supports the internal components of the valve structure 70A. The housing 71 includes a side wall portion 71a and a bottom portion 71b. The side wall portion 71a on the side facing the first hydraulic oil tank 31 defines an opening 71c. The opening 71c is opened, for example, in a circular shape. The side opposite to the first hydraulic oil tank 31 of the side wall portion 71a is coupled to the bottom portion 71b. In the center of the bottom portion 71b, an opening 71d is defined.

The first plunger 72 is a tubular (e.g., cylindrical) member that functions as a valve body. The first plunger 72 includes a main body portion 72a and a flange 72b formed at one end of the main body portion 72a. The flange 72b has, for example, a disc shape with an outer diameter larger than the opening diameter of the opening 71d. The first plunger 72 is arranged within the housing 71 with one end of the main body portion 72a facing away from the first hydraulic oil tank 31. In FIG. 9, the flange 72b abuts against the inner surface of the bottom portion 71b of the housing 71 within the housing 71. In the center of the first plunger 72, a through-hole is formed through which a bolt 78a of the fastening member 78, which will be described later, can be inserted.

The second plunger 73 is a tubular (e.g., cylindrical) member that functions as a valve body. The second plunger 73 is, for example, a disc-shaped member with a smaller diameter than the outer diameter of the flange 72b of the first plunger 72. The second plunger 73 is arranged on the opposite side of the first hydraulic oil tank 31 in relation to the first plunger 72. In FIG. 9, the surface of the second plunger 73 on the side of the first hydraulic oil tank 31 abuts against the surface of the flange 72b on the opposite side of the first hydraulic oil tank 31. In the center of the second plunger 73, a through-hole is formed through which the bolt 78a of the fastening member 78, which will be described later, can be inserted.

The first spring 74 is a spring for the intake of the pressure-regulating valve 70. The first spring 74 is, for example, a coil spring. The first spring 74 has an inner diameter larger than the outer diameter of the main body portion 72a of the first plunger 72. The first spring 74 has an outer diameter smaller than the outer diameter of the flange 72b of the first plunger 72. The first spring 74 is arranged such that one end of the first spring 74 is seated against a surface 72c of the flange 72b on the side of the first hydraulic oil tank 31.

The second spring 75 is a spring for the exhaust of the pressure-regulating valve 70. The second spring 75 is, for example, a coil spring thinner than the first spring 74. The second spring 75 has an inner diameter larger than the outer diameter of the bolt 78a of the fastening member 78. The second spring 75 has an outer diameter smaller than the outer diameter of the main body portion 72a of the first plunger 72. The second spring 75 is arranged such that one end of the second spring 75 is seated against an end surface 72d of the main body portion 72a on the side of the first hydraulic oil tank 31.

The retainer 76 is a tubular (e.g., cylindrical) member for integrally holding the first plunger 72 and the first spring 74. The retainer 76 includes a main body portion 76a and a flange 76b formed at one end of the main body portion 76a. The main body portion 76a has, for example, a cylindrical shape with an outer diameter smaller than the inner diameter of the first spring 74. The flange 76b has, for example, a disc shape with an outer diameter slightly smaller than the inner diameter of the housing 71. In the center of the retainer 76, a through-hole, through which the second spring 75 can be inserted, is formed.

The retainer 76 is arranged within the housing 71 with one end of the main body portion 76a facing the side of the first hydraulic oil tank 31. In FIG. 9, the retainer 76 is inserted through the opening 71c of the housing 71 after the first plunger 72, the first spring 74, and the second spring 75 are arranged inside the housing 71. The retainer 76 is fixed by a snap ring 77 in a state in which the first spring 74 is compressed, with the other end of the first spring 74 seated against a surface 76c of the flange 76b on the opposite side of the first hydraulic oil tank 31. The snap ring 77 is fitted into a groove 71e formed in the inner wall surface on the side of the opening 71c of the housing 71.

The fastening member 78 is a member for integrally holding the first plunger 72, the second plunger 73, and the second spring 75. The fastening member 78 includes a bolt 78a, a washer 78b, and a lock nut 78c. The bolt 78a is inserted from the side of the second plunger 73, through the through-hole of the second plunger 73 and the through-hole of the first plunger 72, and into the second spring 75, with the retainer 76 fixed by the snap ring 77, as described above. The lock nut 78c is screwed onto the bolt 78a, with the other end of the second spring 75 seated against the washer 78b. The lock nut 78c is tightened to compress the second spring 75. The fastening member 78 can operate integrally with the second plunger 73. On the opening of the pressure-regulating valve 70, the pressure of the space in the first hydraulic oil tank 31 is mainly applied to the lower surface of the second plunger 73, which causes the second plunger 73 to move upward and the head of the bolt 78a to be pushed up, thereby moving the second plunger 73 and the bolt 78a integrally upward. On the closing of the pressure-regulating valve 70, the decrease in the pressure in the space in the first hydraulic oil tank 31 allows the second spring 75 to extend, moving the bolt 78a downward, causing the bolt 78a to press down on the second plunger 73. Moreover, the head of the bolt 78a and the second plunger 73 may be integrated by adhesive or the like.

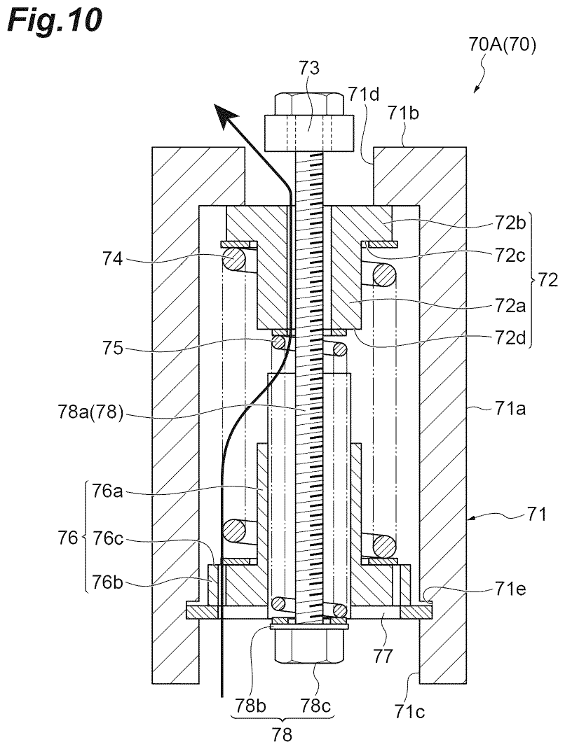

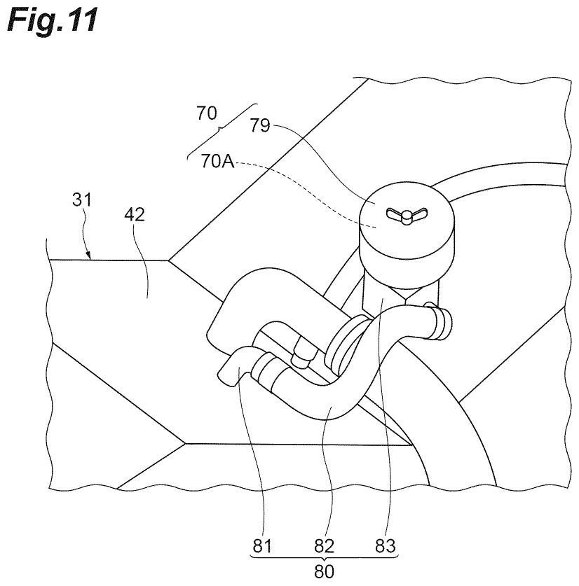

FIG. 10 is a partial cross-sectional view illustrating an exemplary operation of the pressure-regulating valve in FIG. 9. As illustrated in FIG. 10, in the pressure-regulating valve 70 configured as described above, an increase in the pressure of the space in the first hydraulic oil tank 31 applies a force to the fastening member 78 and the second plunger 73, pushing the second plunger 73 upwards in the direction towards the top of the plane in FIG. 10, from the side of the first hydraulic oil tank 31. The bolt 78a, the washer 78b, and the lock nut 78c are pushed up, compressing the second spring 75. The contact (sealing) between the first plunger 72 and the second plunger 73 is released. In other words, when the pressure in the space in the first hydraulic oil tank 31 is higher than or equal to a predetermined pressure, the inside of the first hydraulic oil tank 31 communicates with the outside air. As a result, the air inside the first hydraulic oil tank 31 is discharged to the outside. Moreover, the pressure-regulating valve 70 has a cap 79 provided to cover the valve structure 70A (refer to FIG. 11). The air discharged from the inside of the first hydraulic oil tank 31 through the pressure-regulating valve 70 passes between the housing 71 of the valve structure 70A and the cap 79, and then is discharged to the outside of the pressure-regulating valve 70.

According to the present embodiment, the operational effects equivalent to the first embodiment are achieved. In addition, in the present embodiment, the pressure-regulating valve 70 is provided in place of the breather 44, and so when the pressure in the space in the first hydraulic oil tank 31 is higher than or equal to a predetermined pressure, the inside of the first hydraulic oil tank 31 communicates with the outside air. This arrangement enables the pressure in the space in the first hydraulic oil tank 31 to be made higher than atmospheric pressure. As a result, the hydraulic oil pump 37 can easily draw up the hydraulic oil L from the first hydraulic oil tank 31. This leads to the possibility of extending the service life of the hydraulic oil pump 37.

The present invention is not limited to the above-described embodiments, and various modifications are possible within the scope of the spirit of the invention, and for example, the following modifications may be made.

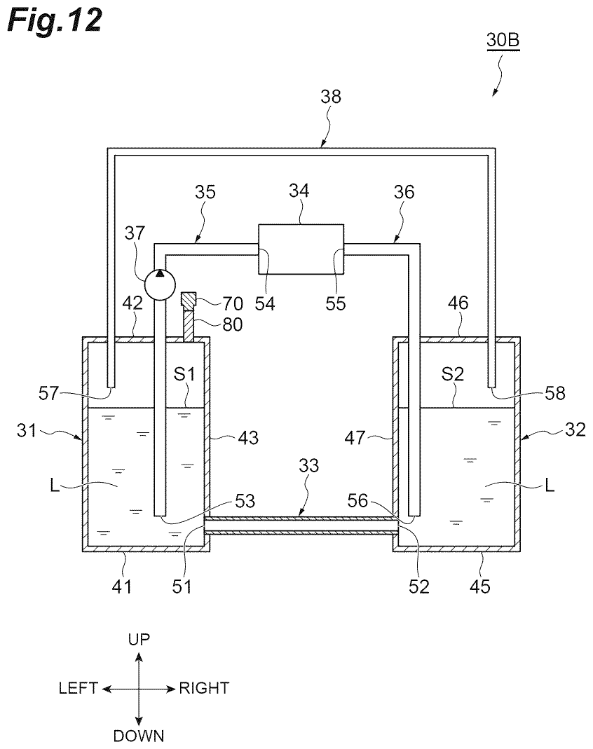

In the above-mentioned embodiment, the breather 44 and the pressure-regulating valve 70 are directly connected to the top plate 42 of the first hydraulic oil tank 31, but this configuration is not limited to the above-mentioned exemplary embodiment. The breather 44 and the pressure-regulating valve 70 may be indirectly connected to the top plate 42 of the first hydraulic oil tank 31 via a pipe. For example, FIG. 11 is a schematic perspective view illustrating an exemplary mounting configuration of the breather and the pressure-regulating valve to the first hydraulic oil tank. FIG. 12 is a configuration diagram schematically illustrating a hydraulic oil supply device for a forklift having the mounting configuration illustrated in FIG. 11. In a hydraulic oil supply device 30B illustrated in FIGS. 11 and 12, the pressure-regulating valve 70 arranged inside the cap 79 is indirectly connected to the top plate 42 of the first hydraulic oil tank 31 via a pipe 80. The pipe 80 may include, for example, a tank-side pipe 81, a rubber hose 82, and a mounting block 83. The rubber hose 82 may be curved or straight depending on the shape of the first hydraulic oil tank 31 and the second hydraulic oil tank 32. The mounting block 83 may not be provided. The indirect connection via the pipe as illustrated in FIGS. 11 and 12 increases the flexibility of arranging the breather 44 and the pressure-regulating valve 70. This allows the layout of parts around the first hydraulic oil tank 31 to be less likely to be restricted, enabling for easy arrangement of the breather 44 and the pressure-regulating valve 70.

In the above-mentioned embodiments, the first hydraulic oil tank and the second hydraulic oil tank are arranged as a pair on the left and right sides of the vehicle body, but this configuration is not limited to the above-mentioned exemplary embodiments. In one example, the first hydraulic oil tank and the second hydraulic oil tank may be arranged as a pair in the front and rear of the vehicle body. In this case, the slope of the vehicle body corresponds to an inclination where the front side of the vehicle body is higher and the rear side is lower, or an inclination where the front side of the vehicle body is lower and the rear side is higher. Although the above-mentioned embodiments describe the hydraulic oil supply device for a forklift as an industrial vehicle, this description is not limited to the above-mentioned exemplary embodiments. The industrial vehicle includes not only forklifts but also, for example, unmanned transport vehicles, towing tractors, or even construction vehicles.

In the above-mentioned embodiments, the hydraulic oil is stored in the first hydraulic oil tank and the second hydraulic oil tank such that there is a gap between the first open-end portion and the second open-end portion of the upper communication pipe and the oil level, but this configuration is not limited to the above-mentioned exemplary embodiments. In one example, the hydraulic oil may be stored so that the oil level is at the same height as the opening height of the first open-end portion and the opening height of the second open-end portion. The hydraulic oil may also be stored in such a way that the first open-end portion and the second open-end portion interfere with or are immersed in the hydraulic oil. In this case, when the vehicle body is in a horizontal position, the oil level in the second hydraulic oil tank hardly rises above the second open-end portion immediately after the hydraulic oil pump starts rotating. Even if the vehicle body is tilted, the oil level will hardly change.

In the above-mentioned embodiments, although the first hydraulic oil tank and the second hydraulic oil tank have substantially the same configuration, this arrangement is not limited to the above-mentioned exemplary embodiments. The first hydraulic oil tank and the second hydraulic oil tank may have different shapes or capacities.

In the above-mentioned embodiments, the opening height of the discharge port 56 of the second hydraulic oil pipe 36 is set to be the same as the opening height of the suction port 53 of the first hydraulic oil pipe 35, but this configuration is not limited to the above-mentioned exemplary embodiments. The opening height of the discharge port 56 may be higher than that of the suction port 53. The opening height of the discharge port 56 may be lower than that of the suction port.

Moreover, the upper communication pipe 38 may be provided with a valve that opens under a predetermined condition (e.g., when the vehicle body 11 is tilted at a predetermined tilt angle or more, based on a tilt angle sensor). In this case, depending on the inflow of air in the upper communication pipe 38, it is possible to allow the movement of the hydraulic oil from the second hydraulic oil tank to the first hydraulic oil tank at a desired timing, such as the case where the vehicle body 11 is tilted at a predetermined tilt angle or more.

Moreover, the constituent requirements of various aspects of the present disclosure are described below.

### <First Aspect of Invention>

A hydraulic oil supply device for an industrial vehicle, including: a first hydraulic oil tank configured to store hydraulic oil;
a second hydraulic oil tank configured to store the hydraulic oil;
an upper communication pipe configured to communicate an upper part of the first hydraulic oil tank with an upper part of the second hydraulic oil tank;
a lower communication pipe configured to communicate a lower part of the first hydraulic oil tank with a lower part of the second hydraulic oil tank to flow the hydraulic oil;
a first hydraulic oil pipe configured to communicate the first hydraulic oil tank with a hydraulic oil supply target subjected to supplying the hydraulic oil and to be provided, in the first hydraulic oil tank, with a suction port adapted to draw the hydraulic oil;
a second hydraulic oil pipe configured to communicate the hydraulic oil supply target with the second hydraulic oil tank and to be provided with a discharge port adapted to discharge the hydraulic oil to be returned to the second hydraulic oil tank; and
a hydraulic oil pump configured to draw up the hydraulic oil from the first hydraulic oil tank,
wherein the second hydraulic oil tank is an airtight tank sealed hermetically against outside air,
the upper communication pipe has
a first open-end portion provided inside the first hydraulic oil tank and
a second open-end portion provided inside the second hydraulic oil tank,
the first open-end portion has an opening height higher than an opening height of the suction port, and
the second open-end portion has an opening height higher than an opening height of the discharge port.

### <Second Aspect of Invention>

The hydraulic oil supply device for the industrial vehicle according to the first aspect of the invention further includes a breather connected to the first hydraulic oil tank.

### <Third Aspect of Invention>

The hydraulic oil supply device for the industrial vehicle according to the first aspect of the invention further includes a pressure-regulating valve connected to the first hydraulic oil tank and configured to communicate an interior of the first hydraulic oil tank with outside air upon a pressure in a space in the first hydraulic oil tank higher than or equal to a predetermined pressure.

### <Fourth Aspect of Invention>

In the hydraulic oil supply device for the industrial vehicle according to any one of the first to third aspects of the invention, the opening height of the second open-end portion is lower than the opening height of the first open-end portion or is the same as the opening height of the first open-end portion.

### <Fifth Aspect of Invention>

The hydraulic oil supply device for the industrial vehicle according to any one of the first to fourth aspects of the invention further includes a third hydraulic oil pipe configured to communicate the second hydraulic oil tank with the hydraulic oil supply target and provided, in the second hydraulic oil tank, with a suction port adapted to draw the hydraulic oil, and a second hydraulic oil pump configured to draw up the hydraulic oil from the second hydraulic oil tank.

### REFERENCE SIGNS LIST

10 FORKLIFT
11 VEHICLE BODY
12 LOAD-HANDLING DEVICE
13 DRIVER'S COMPARTMENT
15 DRIVER'S SEAT
18 STEERING WHEEL
22 LIFT BRACKET
23 FORK
30, 30A, 30B, 60 HYDRAULIC OIL SUPPLY DEVICE FOR INDUSTRIAL VEHICLE
31 FIRST HYDRAULIC OIL TANK
32 SECOND HYDRAULIC OIL TANK
33 LOWER COMMUNICATION PIPE
34 HYDRAULIC OIL SUPPLY TARGET
35 FIRST HYDRAULIC OIL PIPE
36 SECOND HYDRAULIC OIL PIPE
37 HYDRAULIC OIL PUMP
38 UPPER COMMUNICATION PIPE
44 BREATHER
53, 63 SUCTION PORT
56 DISCHARGE PORT
57 FIRST OPEN-END PORTION
58 SECOND OPEN-END PORTION
61 THIRD HYDRAULIC OIL PIPE
62 SECOND HYDRAULIC OIL PUMP
70 PRESSURE-REGULATING VALVE
L HYDRAULIC OIL
S1, S2, Sm OIL LEVEL
ΔH HYDRAULIC HEAD (HEAD) DIFFERENCE

1. A hydraulic oil supply device for an industrial vehicle, comprising: a first hydraulic oil tank configured to store hydraulic oil;
a second hydraulic oil tank configured to store the hydraulic oil;
an upper communication pipe configured to communicate an upper part of the first hydraulic oil tank with an upper part of the second hydraulic oil tank;
a lower communication pipe configured to communicate a lower part of the first hydraulic oil tank with a lower part of the second hydraulic oil tank to flow the hydraulic oil;
a first hydraulic oil pipe configured to communicate the first hydraulic oil tank with a hydraulic oil supply target subjected to supplying the hydraulic oil and to be provided, in the first hydraulic oil tank, with a suction port adapted to draw the hydraulic oil;
a second hydraulic oil pipe configured to communicate the hydraulic oil supply target with the second hydraulic oil tank and to be provided with a discharge port adapted to discharge the hydraulic oil to be returned to the second hydraulic oil tank; and
a hydraulic oil pump configured to draw up the hydraulic oil from the first hydraulic oil tank,
wherein the second hydraulic oil tank is an airtight tank sealed hermetically against outside air,
the upper communication pipe has
a first open-end portion provided inside the first hydraulic oil tank and
a second open-end portion provided inside the second hydraulic oil tank,
the first open-end portion has an opening height higher than an opening height of the suction port, and
the second open-end portion has an opening height higher than an opening height of the discharge port.

2. The hydraulic oil supply device for the industrial vehicle according to claim 1, further comprising a breather connected to the first hydraulic oil tank.

3. The hydraulic oil supply device for the industrial vehicle according to claim 1, further comprising a pressure-regulating valve connected to the first hydraulic oil tank and configured to communicate an interior of the first hydraulic oil tank with outside air upon a pressure in a space in the first hydraulic oil tank higher than or equal to a predetermined pressure.

4. The hydraulic oil supply device for the industrial vehicle according to claim 1, wherein the opening height of the second open-end portion is lower than the opening height of the first open-end portion or the same as the opening height of the first open-end portion.

5. The hydraulic oil supply device for the industrial vehicle according to claim 1, further comprising a third hydraulic oil pipe configured to communicate the second hydraulic oil tank with the hydraulic oil supply target and provided, in the second hydraulic oil tank, with a suction port adapted to draw the hydraulic oil; and
a second hydraulic oil pump configured to draw up the hydraulic oil from the second hydraulic oil tank.
